(19) United States
(12) Patent Application Publication
(10) Pub. No.: US 2004/0105453 A1
(43) Pub. Date: Jun. 3, 2004

(54) Capacity re-use in data communication networks

(76) Inventors: Dale John Shpak, Columbia (CA); Abdu Omran, Columbia (CA)

Correspondence Address: Barnes & Thornburg, 11 South Meridian Street, Indianapolis, IN, 46204, US

(21) Appl. No.: 10/472,474

(22) PCT Filed: Aug. 14, 2001
(86) PCT No.: PCT/US01/41708

(51) Int. Cl. H04L 12/28

(52) U.S. Cl. 370/404

(57) ABSTRACT

A method and apparatus to improve the bandwidth utilization of a data transport network, such as SONET or SDH. Using knowledge of the topology, the network capacity that in the prior art was used to taxi the data to the sending node (2.1-2.4, 2.15, 2.16, 4.1-4.4, 5.1, 9.8) is instead used to send new data between nodes (2.1-2.4, 2.15, 2.16, 4.1-4.4, 5.1, 9.8). The method and apparatus can also be used to eliminate the bandwidth-inefficient taxiing of frames that are blocked and recirculated. by busy nodes (2.1-2.4, 2.15, 2.16, 4.1-4.4, 5.1, 9.8) in SONET-based data networks.

### CROSS-REFERENCE TO RELATED APPLICATIONS

This is a regular utility patent application of U.S. S. No. 60/279,101 filed Mar. 28, 2001, the priority of which is hereby claimed, and the disclosure of which is hereby incorporated herein by reference.

### FIELD OF THE INVENTION

This invention relates to telecommunication network systems. It is disclosed in the context of a system for transporting and distributing data among network elements in, for example, a Synchronous Optical NETwork (SONET) or Synchronous Digital Hierarchy (SDH) transport. However, it is believed to be useful in other applications as well.

### BACKGROUND OF THE INVENTION

The demand for bandwidth in data communication networks is doubling every six months. It is unlikely that this growth in demand will diminish in the immediate future. Indeed, there are reasonably reliable predictions that it may accelerate. As voice over Internet Protocol (VoIP), storage over IP, streaming multimedia, Internet appliances and wireless 3G networks proliferate, the demand for bandwidth will only increase.

Telecommunication service providers are faced with two significant obstacles to this explosive growth. First, existing, or legacy, telecom networks were not designed to transport packet-based data efficiently, and certainly were not designed to scale up in data-handling capacity at the rate that packet-based data traffic is increasing. Second, most existing telecoms' primary revenue streams are based on voice data, while their fastest-rising and most significant demands and costs are those associated with the increase of packet-based data traffic. Thus, the telecoms are faced with a dilemma. They can either invest significant amounts of capital to build high-capacity data networks or risk obsolescence.

Data is generally switched two ways. Voice, for example, has historically been circuit switched. In a circuit switched network each data stream is sent over a circuit between the sender and the receiver. This circuit is dedicated for exclusive use for the duration of the data transmission. Although circuit switching is convenient for voice data such as telephone calls, it is very inefficient for other types of data communications. Digital data, such as a file being downloaded, is generally packet switched. That is, a data file is segmented into multiple packets. The individual packets are then sent along whatever path(s) is (are) available to their destination where they are reassembled into the transmitted file.

Historically, telecoms only had to transport voice traffic. Data traffic came along much later, and input/output devices were developed to interface data sources with telecoms' legacy networks. By the mid-to-late eighties, telecoms had developed the practice of maintaining distinct parallel networks for voice and data. The voice networks remained circuit switched. The data networks were packet switched. In the early nineties, the first efforts began to converge network switching to the packet switching model.

In the early nineties, telecommunication engineers began developing mechanisms for connecting the separate voice and data networks to a common SONET ring. SONET (as well as SDH, the standard widely used outside of North America) permitted multiple services based on Time Division Multiple Access (TDMA) to be multiplexed from lower-speed, for example, voice, circuits into layers in the SONET hierarchy. The tremendous bandwidth available over the common SONET/SDH interface made it attractive to carry IP traffic over a frame relay and/or an Asynchronous Transfer Mode (ATM) backbone network. As the volume of IP traffic increases, it becomes more desirable to carry IP traffic directly over SONET, at least in the network backbone where demand is high and increasing.

Currently, the focus of IP transport continues to be data-oriented. However, a significant trend in the industry is the emerging demand for the support of real-time IP services, such as IP telephony. With the increasing demand for such services, there is an attendant need to develop SONET/SDH data routers with sophisticated Quality of Services (QoS) mechanisms.

By the mid nineties, telecommunication engineers routinely encountered the need to efficiently transport and route large amounts of packet-formatted data, namely IP data, originating from Local Area Networks (LANs). The solution they developed was to locate ATM networks as intermediate transport layers between the LANs and backbone SONET rings. In the short term, ATM was a good solution. ATM provided extensive bandwidth management, wire speed switching, network based addressing, routing, and QoS control over the network. ATM also provided for the convergence of circuit-switched data (such as voice) and packet-switched data (such as IP-based file transfers) onto a single transport system.

However, ATM layer was not a perfect solution. An ATM network is a cell-based network, and the Public Switched Telephone Network (PSTN) is Time Division Multiplexed (TDM). Telecommunication engineers used ATM networks in the beginning to transport circuit-switched data such as T1, at 1.544 Mb/s, and DS-3. (45 Mb/s). The overhead resulting from ATM headers and data packetization resulted in inefficiency in bandwidth utilization. Additionally there is some time delay associated with ATM because ATM is connection oriented and a connection takes a finite time to set up. Further, to transport circuit-switched data over an ATM network requires equipment called a Circuit Emulation Switch (CES) to convert the TDM traffic to ATM cells for transport. Then, as the traffic arrives at its destination it must be converted back to TDM. This added functionality and control is expensive both in terms of the overhead bandwidth and the capital cost of adding another network layer.

By the late nineties, IP had evolved to the point at which it incorporated much of the network management functionality of ATM. Now it was possible to transport IP packets over SONET without requiring an intermediate ATM layer. However, the Packet Over SONET (POS) protocol that was developed for this purpose requires the IP data to undergo an encapsulation process. This process includes a costly segmentation and reassembly of the packet. In some cases the POS protocol was then transported over ATM, resulting in further inefficiencies resulting in 40 to 45% of the system bandwidth being used for overhead.

With existing POS systems, Point-to-Point Protocol (PPP) is used with the SONET ring because SONET was originally designed as a point-to-point network. In these systems, the packet must pass through multiple nodes in the network and be regenerated at each node for transit to the next node. Also, PPP alone is not sufficient for true data encapsulation. It can be used for mapping and translation only if the X.25 High-Level Data Link Control (HDLC) protocol and a mechanism called Address Resolution Protocol (ARP) are employed to translate and map each data packet to its destination through the point-to-point SONET network. However, this requires stripping out the HDLC frame at each node, analyzing the header and then re-packaging it for the next PPP link.

SONET was originally designed to be a simple transport system for TDM voice signals that could be used at high line rates using,. by modem standards, relatively simple electronics. Because of this, SONET protocols are less well suited as data transport protocols than protocols specifically designed for data transmission, such as IP or ATM. SONET engineers have focused on increasing line rates and improving administration tools rather than improving the intrinsic data transport performance of SONET. To date, data transport over SONET has been accomplished by adding protocol layers above the SONET transport layer.

With many of the existing routing and data transfer protocols approaching their speed and bandwidth limits, some network engineers have turned their attention to increasing the raw bandwidth of SONET rings. Many solutions have developed around large channel-count Dense Wavelength Division Multiplexing (DWDM) and running the rings at very high speeds, up to Optical Carrier-768 (OC-768). These “brute force” solutions of simply making available the capacity to transmit photons at a greater number of discrete frequencies around the ring are capital intensive and complex. Every time a wavelength is split, for example, at a node in a DWDM network, the signal strength is divided. Thus, the optoelectronics must be able to process increasingly fainter signals. When the whole system is run at very high speeds, the problems are compounded. Indeed, many speculate that OC-768 optoelectronics can only be made from esoteric compound semiconductors such as InP.

The present invention proposes an alternative to this brute force approach, namely to identify and remedy inefficiencies, thereby improving the utilization of the existing SONET infrastructure.

Another important aspect of modern data communications is the increasing importance of reliability and latency. Telephone services require a very high level of availability and low latency. The normal standard of operation is the so-called “five nines” standard of reliability. That is, the system must be available 99.999% of the time. This corresponds to an acceptable outage of five minutes per year. Although this provides an excellent level of service, the emerging standard is “six nines.” That is, the system must be available 99.9999% of the time. Many existing IP network technologies (such as Ethernet LANs) do not have high levels of reliability and predictable latency because they were not developed for voice transport. At the same time, as the Internet evolves and an increasing amount of loss-sensitive and time-critical information is transported using IP packets, there is a corresponding increase in demand for reliable transport of IP traffic. This is one of the reasons why SONET remains an attractive technology for the transport of IP traffic.

One of the reasons for SONET's reliability is that, in most installations, data circulates in opposite directions around two optical fiber rings to provide redundant connectivity between the nodes. FIG. 1 illustrates a typical SONET Unidirectional Path Switched Ring (UPSR) in which data frames 1.5 and 1.6 flow in opposite directions in the two rings 1.7 and 1.8. Under normal operation, only one of the rings (the “working” ring 1.8) is in use and the other ring (the “protection” ring 1.7) is only used when there is a failure in the working ring. This permits the network to continue to operate in the event of disruption of the working ring or network equipment such as an Add/Drop Multiplexer (ADM) 1.1-1.4 at any location along the working ring. SONET systems have Automatic Protection Switching (APS) to detect signal failures and switch traffic between the working and protection rings to isolate and direct traffic around the fault. If the SONET system is being used to transport IP traffic, the ADMs typically will be connected to IP routers 1.9, 1.11, 1.13.

As noted above, SONET uses TDM to multiplex and demultiplex low-speed data traffic to or from a high-speed optical transport network. Each such low-speed connection is semi-permanently allocated a fraction of the capacity of the high-speed ring by “provisioning” bandwidth. This provisioning assigns bandwidth from each node to each other node. This provisioning can be thought of as a multi-lane highway in which a lane is allocated for traffic from one ADM to another ADM. Since SONET is a TDM system, the lanes are provisioned by allocating time slots in the TDM sequence. With provisioning, the communication between each pair of ADMs is point-to-point. That is, if a specific set of time slots are provisioned for sending traffic 1.6 from ADM 1.4 to ADM 1.1 along the working ring illustrated in FIG. 1, that provisioned capacity is not used for any other purpose by the equipment on the ring. ADMs not using a particular lane simply forward traffic not addressed to them, without inspecting or otherwise processing it.

This invention, which is sometimes referred to hereinafter as Frame Stealth Re-use (FSR), improves the efficiency of SONET systems by re-using network capacity that is wasted in existing SONET systems. FSR is a form of transparent reuse of transport capacity. Nodes incorporating this capacity will sometimes be referred to hereinafter as FSR-capable nodes. FSR is compliant with SONET standards and is compatible with existing SONET-compliant network equipment. Unlike other proposed systems that require the expensive upgrading or replacement of existing equipment, it is compatible with existing SONET systems. Thus, it can operate transparently on rings containing legacy equipment. The invention permits network nodes to send traffic to each other without requiring that any bandwidth be specifically allocated to them. Bandwidth re-use according to the invention is transparent to existing equipment.

### DISCLOSURE OF THE INVENTION

According to the present invention, a method and apparatus are described which reuse bandwidth and increase the capacity of networks to transport data. The present invention solves the problem of providing increased network capacity without requiring the upgrading of existing network equipment or the installation of new fiber rings.

According to one aspect of the invention, a method is provided for transmitting data in a direction along a circuit coupling a first node from which first data is to be transmitted and a second node at which the first data is to be received and from which second data is to be transmitted. The method includes assembling the first data into a frame at the first node for transmission to the second node, transmitting the frame including the first data from the first node, receiving the frame including the first data at the second node, removing at least a portion of the transmitted first data from the frame and replacing the removed first data with second data, and transmitting the frame containing the second data from the second node.

According to another aspect of the invention, a method is provided for transmitting data in a direction along a circuit coupling a first node from which first data is to be transmitted, a second node at which the first data is to be received and second data is to be transmitted, and a third node at which the second data is to be received and other data is to be transmitted. The method includes assembling the first data into a frame for transmission to the second node and transmitting the frame including the first data in the direction from the first node. The method further includes receiving the frame including the first data at the second node, removing at least a portion of the transmitted first data from the frame and replacing at least a portion of the removed first data with the second data and transmitting. the frame in the direction from the second node. The method also includes receiving the frame at the third node, removing from the frame at least a portion of the second data, replacing at least a portion of the removed second data with other data and transmitting the frame in the direction from the third node.

Illustratively according to this aspect of the invention, providing a third node includes providing a third node between the second node and the first node in the direction.

Further illustratively according to this aspect of the invention, replacing at least a portion of the removed second data with other data includes replacing at least a portion of the removed second data with removed first. data.

Alternatively illustratively according to this aspect of the invention, providing a third node includes providing a third node between the first node and the second node in the direction.

Further illustratively according to this aspect of the invention, providing a circuit includes providing a circuit supporting at least a first channel and a second channel. Transmitting the frame including the first data in the direction from the first node, receiving the frame including the first data at the second node, removing at least a portion of the transmitted first data from the frame and replacing at least a portion of the removed first data with second data, transmitting the frame in the direction from the. second node,. receiving the frame. at the third node, removing from the frame at least a portion of the second data, and transmitting the frame in the direction from the third node together include transmitting the frame including the first data in the direction from the first node on the first channel, receiving the frame including the first data at the second node on the first channel, removing at least a portion of the transmitted first data from the frame and replacing at least a portion of the removed first data with second data, transmitting the frame in the direction from the second node on the second channel,-receiving the frame at the third node on the second channel, removing from the frame at least a portion of the second data, and transmitting the frame in the direction from the third node.

Illustratively according to this aspect of the invention, the method further includes replacing at the third node at least a portion of the removed first data before transmitting the frame without the removed portion of the transmitted second data from the third node.

According to another aspect of the invention, a method is provided for transmitting data along a circuit coupling a first node from which first data is to be transmitted, a second node from which second data is to be transmitted, and a third node at which the first data is to be received. The method includes assembling the first data into a first frame for transmission, transmitting the first frame from the first node, receiving the first frame including the first data at the second node, removing at least a portion of the transmitted first data from the first frame and replacing at least a portion of the removed first data with the second data, transmitting the first frame from the second node, assembling at least a portion of the removed first data into a second frame, transmitting the second frame from the second node, receiving the second frame at the third node, and removing from the second frame at least a portion of the first data removed from the first frame and assembled into the second frame.

Illustratively according to this aspect of the invention, the method further includes transmitting from the first node a third frame containing third data to be received at the third node, receiving the third frame including the third data at the second node, removing at least a portion of the third data from the third frame, and assembling at least a portion of the removed third data into the second frame along with the first data removed from the first frame and assembled into the second frame at the second node before transmitting the second frame. from the second node and receiving the second frame at the third node. According to this aspect of the invention, removing from the second frame at least a portion of the first data removed from the first frame and assembled into the second frame includes removing from the second frame at least a portion of the third data removed from the third frame and assembled into the second frame.

According to another aspect of the invention, a method is provided for transmitting data in a direction along a circuit coupling a first node from which first data is to be transmitted, a second node at which the first data is to be received, and a third node from which the second data is to be transmitted. The method includes assembling the first data into a frame at the first node for transmission and transmitting the frame including the first data from the first node. The method further includes receiving the frame including the first data at the second node, removing at least a portion of the transmitted first data from the frame, replacing the removed first data with an indication that the portion of the frame previously occupied by the removed portion of the first data is available for data transport and transmitting the frame containing the indication from the second node. The method also includes receiving the frame containing the indication at the third node, removing from the frame at least a portion of the indication, replacing the removed portion of the indication with the second data and transmitting the frame from the third node.

According to yet another aspect of the invention, apparatus is provided for transmitting data in a direction along a circuit. The apparatus includes a first node for assembling first data into a frame and transmitting the first data through the circuit in the direction. The apparatus further includes a second node for receiving the frame transmitted through the circuit in the direction, removing at least a portion of the transmitted first data from the frame, replacing the removed first data with second data and transmitting the frame containing the second data through the circuit in the direction.

According to another aspect of the invention, apparatus is provided for transmitting data in a direction along a circuit. The apparatus includes a first node for assembling first data into a frame and transmitting the-frame through the circuit in the direction. The apparatus further includes a second node for receiving the frame transmitted through the circuit in the direction, removing at least a portion of the transmitted first data from the frame, replacing the removed first data with second data and transmitting the frame containing the second data through the circuit in the direction. The apparatus also includes a third node for receiving the frame transmitted through the circuit in the direction, removing from the frame at least a portion of the second data, replacing the removed second data with other data, and transmitting the frame in the direction from the third node.

Illustratively according to this aspect of the invention, the third node is oriented between the second node and the first node in the direction.

Further illustratively according to this aspect of the invention, the third node for replacing the at least a portion of the removed second data with other data includes a third node for replacing at least a portion of the removed second data with removed first data.

Alternatively illustratively according to this aspect of the invention, the third node is oriented between the first node and the second node in the direction.

Further illustratively according to this aspect of the invention, the circuit includes at least a first channel and a second channel. The first node transmits the frame including the first data in the direction on the first channel. The second node receives the frame including the first data on the first channel and transmits the frame with at least a portion of the first data removed and replaced by the second data on the second channel. The third node receives the frame on the second channel and transmits the frame.

Additionally illustratively according to this aspect of the invention, the third node replaces at least a portion of the removed first data before transmitting the frame without the removed portion of the transmitted second data.

According to still another aspect of the invention, apparatus is provided for transmitting data along a circuit. The apparatus includes a first node for assembling first data into a first frame and transmitting the first data. The apparatus further includes a second node for receiving the first frame including the first. data, removing at least a portion of the transmitted first data from the first frame, replacing at least a portion of the removed first data with second data, transmitting the first frame, assembling at least a portion of the removed first data into a second frame, and transmitting the second frame. The apparatus also includes a third node for receiving the second frame and removing from the second frame at least a portion of the first data removed from the first frame and assembled into the second frame.

Illustratively according to this aspect of the invention, the first node transmits a third frame containing third data to be received at the third node. The second node receives the third frame including the third data, removes at least a portion of the third data from the third frame, and assembles at least a portion of the removed third data into the second frame along with the first data removed from the first frame and assembled into the second frame, and then transmits the second frame from the second node. The third node removes from the second frame at least a portion of the first data removed from the first frame and assembled into the second frame and at least a portion of the third data removed from the third frame and assembled into the second frame.

According to yet another aspect of this invention, apparatus is provided for transmitting data in a direction along a circuit. The apparatus includes a first node for assembling the first data into a frame for transmission and transmitting the frame including the first data. The apparatus also includes a second node for receiving the frame including the first data, removing at least a portion of the transmitted first data from the frame, replacing the removed first data with an indication that the portion of the frame previously occupied by the removed portion of the first data is available for data transport and transmitting the frame containing the indication from the second node. The apparatus further includes a third node for receiving the frame containing the indication, removing from the frame at least a portion of the indication, replacing the removed portion of the indication with the second data and transmitting the frame from the third node.

### BRIEF DESCRIPTION OF THE DRAWINGS

The invention may best be understood by referring. to the following detailed description and accompanying drawings-which illustrate the invention. In the drawings:

FIG. 1 is a schematic illustration of a SONET UPSR network;

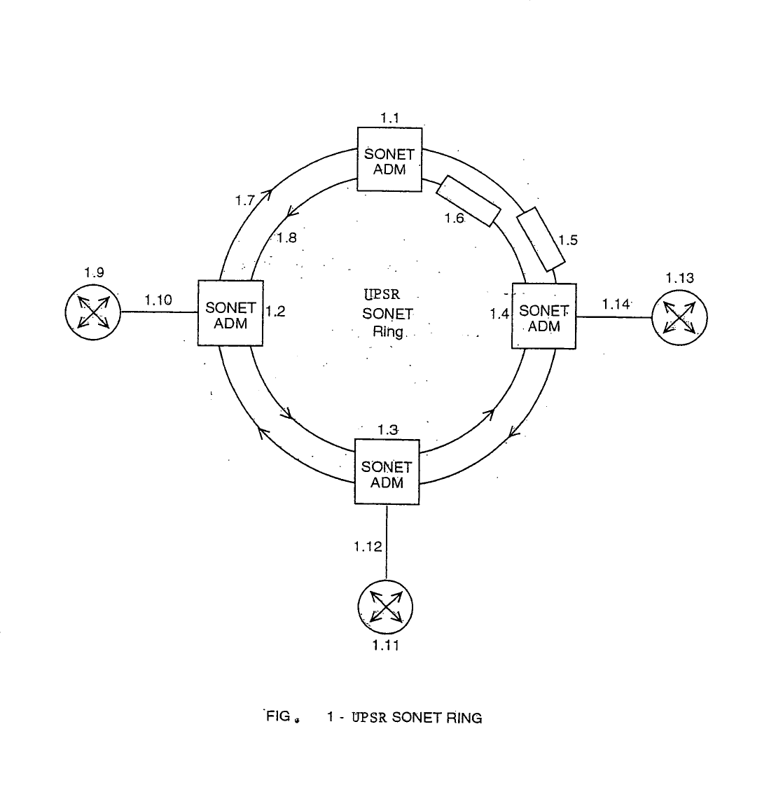

FIG. 2 is a schematic illustration of a SONET UPSR network with additional FSR-capable nodes;

FIG. 3 illustrates contents of a SONET Synchronous Transport Signal level 1 (STS-1) frame;

FIG. 4 illustrates the flow of traffic in a four-node SONET UPSR network;

FIG. 5 illustrates high-level schematic diagram of a network node;

FIG. 6 illustrates a detailed schematic diagram of one apparatus for implementing the invention;

FIG. 7 illustrates a flow diagram of a process performed to replace a silent tributary with a tributary containing FSR data;

FIG. 8 illustrates a flow diagram of a process performed to receive a tributary that may contain FSR data; and

FIG. 9 illustrates a combined process flow diagram and data flow diagram of a process performed when aggregating partially-filled ingress frames and local traffic into a tributary containing FSR data.

### DETAILED DESCRIPTION OF AN ILLUSTRATIVE EMBODIMENT

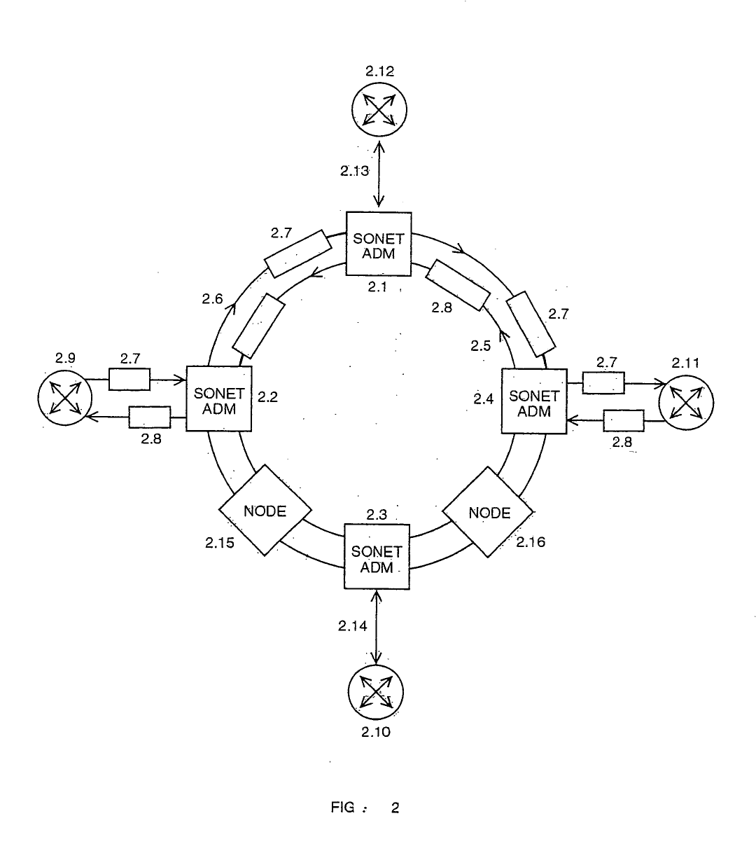

FSR-capable nodes on the SONET ring illustrated in FIG. 2 are made aware of the network topology of the existing SONET nodes 2.1-2.4 on the ring plus nodes 2.15, 2.16 that have FSR capabilities. The topology information can be entered explicitly or the system can use a topology discovery protocol to aid in determining the topology.

Prior art SONET rings use source-dropped frames. In such rings, when a node 2.4 sends a frame 2.8 and that frame reaches the destination node 2.1, typically after passing through other nodes that simply forward the frame, the frame continues to “taxi” around the ring 2.5 until it returns the originating node 2.4. In existing SONET systems, the return of egress frames to the originating node was done for simplicity of implementation. The return of these frames is not necessary and is essentially a waste of ring capacity.

Rather than wasting network capacity by taxiing frames back to their source after they have reached their destinations, an FSR-capable node 2.15 replaces these taxiing frames with “stealth” frames carrying data which needs to be transported. These new frames can then be sent to any selected node 2.3, 2.16 having a destination that is topologically between the FSR-capable node 2.15 and the source of the original frame in the direction in which traffic circulates around the ring 2.5. In this way, network bandwidth that was used to taxi the frame back to the original source node is re-used to carry new data between nodes.

FSR-capable nodes can also be used to transport the newly inserted stealth frames to nodes that are topologically beyond the original source node. The FSR-capable nodes can accomplish this by reassigning the provisioned channel used by the inserted stealth frame at any point before that frame reaches the original source node To achieve this, a FSR-capable node drops the stealth frame from one provisioned channel and inserts it into a different provisioned channel so that it can be transported further along the ring.

FSR can be used with voice, data and voice/data networks because it is completely transparent to frame content. Additionally, the silence, idle or other identifiable frames that are often transported between nodes can be identified and temporarily substituted with frames carrying data that needs to be transported. The node receiving the temporarily substituted frame(s) then reconstitutes the required silence or idle frame(s) so that the original destination node of the silence or idle frame(s) receives the correct frame(s).

FSR also improves the performance of certain SONET-based data transport systems, such as those using POS. Input blocking can occur at nodes in these systems as a result of either processing bottlenecks in the node or the blocking of egress traffic on some other interface of the node. When such blocking occurs, the node may not have sufficient capacity to buffer the frame. When this occurs, the node at which such blocking occurs will typically retransmit the frame around the ring. and attempt to process it the next time that it circulates back to the node. This wastes network bandwidth as the blocked frame taxis around the ring. According to the invention, data packets that would normally be retransmitted in separate SONET frames are aggregated and transported to their destination with lower overhead resulting from the aggregation.

SONET has been adapted for the transport of other forms of data traffic such as ATM cells and IP packets. A primary reference document for SONET is Bellcore GR-253 “Synchronous Optical Network Transport System,” which is incorporated herein by reference. SONET multiplexing equipment, such as ADMs sends frames of data to each other over provisioned TDM channels. Because SONET was originally designed for the transport of digitized telephone conversations, the rate at which frames are transmitted is 8 kHz. Since the frame rate is fixed, higher data rates are accommodated by sending larger frames. In the SONET standards, the resulting data rates are integral multiples of 51.84 Mbps, which is referred to as STS-1. These data rates include

| | | |
|---|---|---|
| STS-1 | | 51.84 |
| STS-3 | OC-3 | 155.52 |
| STS-12 | OC-12 | 622.08 |
| STS-48 | OC-48 | 2,488.32 |
| STS-192 | OC-192 | 9,953.28 |

wherein the OC designations are used in the context of data transport over optical links. An OC-12 ring can transport twelve STS-1 tributaries.

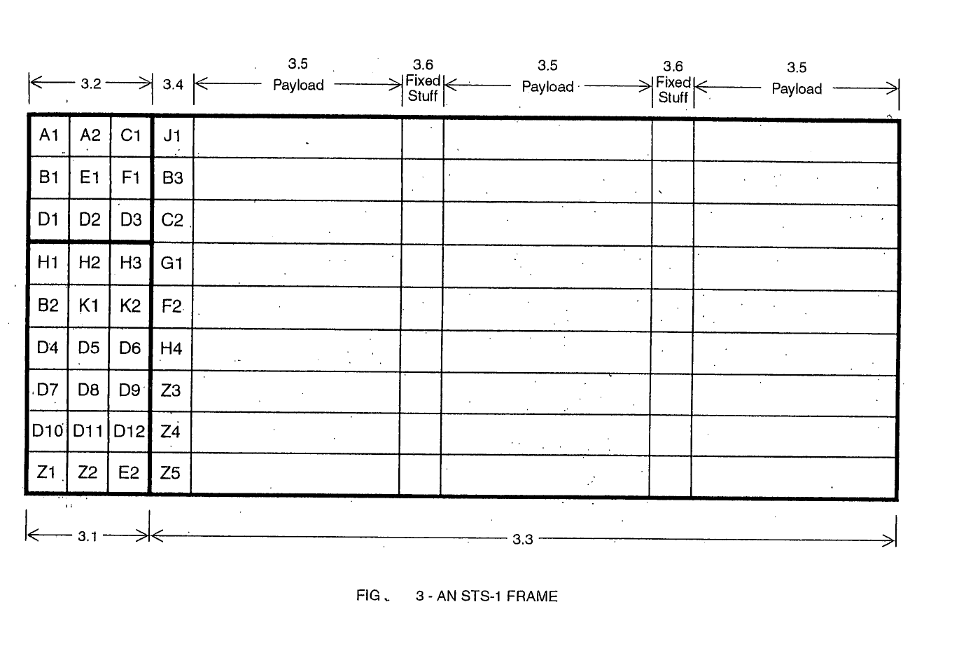

Referring now to FIG. 3, each STS-1 SONET frame includes bytes for line overhead 3.1, bytes for section overhead 3.2, and bytes within the synchronous payload envelope (SPE) 3.3. The SPE contains bytes for path overhead 3.4, bytes for payload 3.5, and fixed stuff 3.6. As illustrated above, multiple STS-1 tributaries can be transported over a higher-speed link. For example, an STS-3 frame contains three STS-1 tributaries which are byte-interleaved inside of the STS-3 frame. Each SONET frame is arranged as nine rows and N columns. The frame data. is transmitted over a serial optical link starting with the first byte in the first row, and proceeding row-wise until the entire frame has been transmitted.

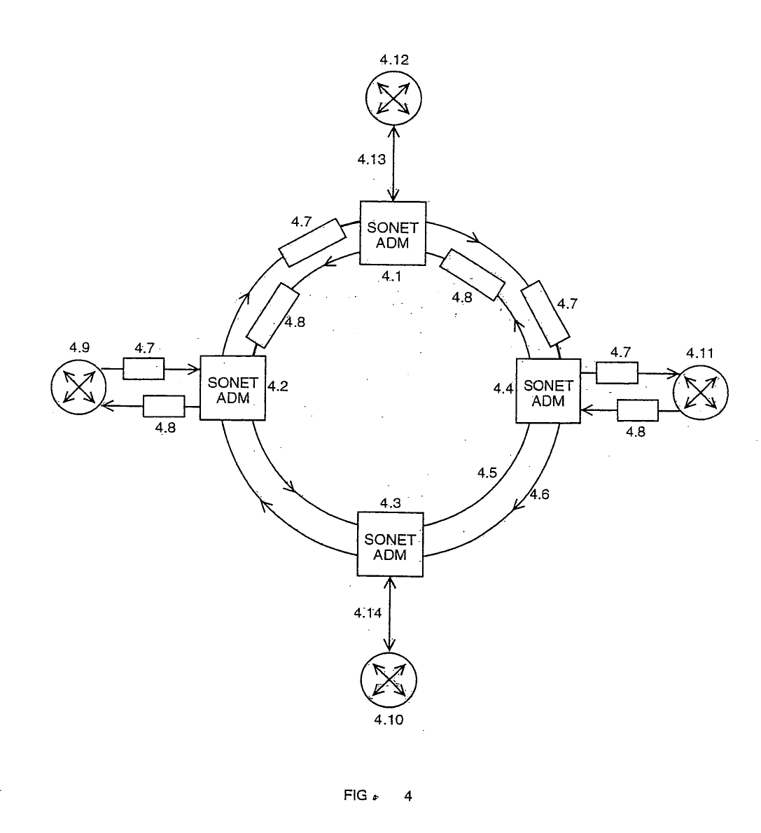

In a typical SONET system illustrated in FIG. 4, a number of nodes 4.1-4.4 (illustrated as ADMs) are interconnected using a dual ring of optical fiber 4.5-4.6. Data frames 4.8 in one ring 4.5 are transported in a first direction, sometimes referred to hereinafter as counter-clockwise. Data frames 4.7 in the other ring 4.6 are transported in a second and opposite direction, sometimes referred to hereinafter as clockwise. Under normal operation, one of the rings, illustratively ring 4.5, is the working ring, and the other, illustratively ring 4.6, is the protection ring. The protection ring 4.6 is only used in the event of failure of an optical fiber or other network equipment in the working ring 4.5. In the event of a failure in the working ring 4.5, the protection ring 4.6 is used to loop traffic back around the ring so that the functioning nodes can still communicate.

When a SONET system is used for data transport, such as IP packets, the ADMs 4.1-4.4 are typically connected with other network equipment 4.9-4.12 such as ATM switches or routers, which then forward or route the IP packets to other connected networks, such as Ethernet or ATM networks.

The transport capacity between nodes 4.1-4.4 is provisioned by programming each node 4.1-4.4 to send or receive its data using specified STS-1 tributaries within the SPE. Any STS-1 tributary that is not used by that node 4.1-4.4 for sending or receiving data is forwarded unmodified to the next node 4.1-4.4 along the ring. In an OC-12 ring, for example, if two STS-1 tributaries are provisioned for sending data from node 4.4 to node 4.2, then node 4.1 will forward those STS-1 tributaries without inspecting or modifying them.

As an example of SONET operation, consider sending data over an OC-12 ring between nodes 4.4 and 4.2 using the first and second STS-1 tributaries. Frames 4.8 of data depart from the node 4.4 on fiber-optic ring 4.5 and arrive at node 4.1. Node 4.1 forwards these two tributaries unmodified (although it may act upon other STS-1 tributaries). These two tributaries then continue traveling around the ring 4.5 through node 4.3, and remain unmodified. The frame returns to node 4.4 after being received by node 4.2. However, since the data in these tributaries has already been read by the destination node 4.2, it is not necessary to transport the tributaries back to their source node 4.4. Rather than continuing to transport these tributaries the rest of the way around the ring from node 4.2 to node 4.4 after they have reached their destination node 4.2, the network capacity of these tributaries can be reused.

Referring back to FIG. 2, additional nodes 2.15 and 2.16, are inserted into the ring. Alternatively, existing nodes can be modified to incorporate the invention. Nodes 2.15 and 2.16 are aware of the network topology and the provisioning of the capacity of the fiber optic rings 2.5 and 2.6. When data is sent along the working ring 2.5 from the node 2.4 to node 2.2 and these tributaries egress from node 2.2, node 2.15 replaces these tributaries with tributaries having new data to be transported from node 2.15 to node 2.16. Data inserted into one or more tributaries in this way will sometimes be referred to hereinafter as FSR data. In this way, node 2.15 can transport FSR data to node 2.16 without requiring that any additional network capacity be provisioned for this purpose. Of course, the FSR data supplied by node 2.15 can be destined for node 2.3 instead of node 2.16 if node 2.3 incorporates FSR and the FSR data supplied by node 2.15 is data that is useable by node 2.3. If node 2.3 does not incorporate FSR and is not compatible with the FSR data generated by node 2.15, node 2.3 will not be the destination for the FSR data from node 2.15, but it will forward the FSR data to node 2.16 without inspecting or modifying the FSR data. That is, FSR data transport from node 2.15 to node 2.16 is transparent to the existing equipment at node 2.3.

FSR can be implemented in an arbitrary number of nodes on a ring. However, an FSR-capable node cannot replace the data in a tributary before that data has reached its destination. Further, the destination node for FSR data must be between the node which inserts the FSR data and the node that was provisioned to insert non-FSR data into the tributary. This inserting node is sometimes referred to herein as the originating node. Additionally, the destination for the FSR data can be the originating node.

Consider, for example, FIG. 2. Assume that all nodes have FSR capabilities and that node 2.4 is an originating node using a tributary to send non-FSR data to node 2.2 along the working ring 2.5. Since an FSR-capable node cannot replace the data in a tributary before that data has reached its destination, node 2.1 cannot replaced this tributary to send FSR data to node 2.3. Further, since the destination node for FSR data must be between the node which inserts the FSR data and the node that was provisioned to insert non-FSR data into the tributary, node 2.3 cannot replace the tributary to send FSR data to node 2.1.

It is beneficial to be able to transport FSR data beyond the limits imposed by these restrictions. To circumvent the restrictions, one or more nodes along the requested path can move data from a tributary that will become unavailable for FSR traffic to another tributary that is available for FSR traffic. For example, consider FIG. 2. Assume that all nodes have FSR capabilities. Also assume that the relevant existing provisioned traffic includes node 2.4 using a specified tributary, say tributary number 1, to send non-FSR data to node 2.2; and node 2.15 using a different tributary, say tributary number 2, to send non-FSR data to node 2.16. Data is transported along the working ring 2.5.

In this case, node 2.1 can send FSR data to node 2.3 in the following manner. Node 2.1 sends FSR data using tributary number 2. This FSR data is extracted at node 2.2 and is then transmitted to node 2.15 using tributary number 1. Node 2.15 forwards this tributary to node 2.3. Because node 2.2 switches the data from tributary 1 to tributary 2, the restrictions are not violated.

The invention is well suited for use on provisioned networks, such as SONET, and can also be used when the network capacity is not provisioned. The nodes provide FSR capability from one FSR-capable node to another specific node by using information about the network topology and the provisioning.

The invention can be extended so that any number of FSR-capable nodes sharing the same tributary or group of tributaries serve as potential destinations for FSR data. In this case, when a source node sends FSR data, the data may pass through several FSR-capable nodes before reaching its destination. For example, in FIG. 2, nodes 2.1 and 2.4 are legacy nodes. All of the remaining nodes 2.2, 2.3, 2.15 and 2.16 are FSR-capable. Legacy data, that is, non-FSR data, is sent from node 2.4 to node 2.1 on tributary number 1. Node 2.2 can therefore send FSR data to any of nodes 2.15, 2.3 and/or 2.16 using tributary number 1. Rather than fixing the destination for this FSR data by using a network management system, node 2.2 can indicate a particular destination node by using an address field within the frame. Each possible destination node has a unique address and, upon receipt of the frame, compares its address with the address in the frame. If the addresses match, the node extracts the data. Otherwise, it forwards the data to the next node.

Additionally, if an FSR-capable node extracts FSR data and there are one or more other FSR-capable nodes along the path, any FSR-capable node along the path can insert new FSR data. For example, if node 2.2 sends FSR data that is addressed to node 2.15, then node 2.15 could send FSR data to node 2.3 or node 2.16. Alternatively, node 2.15 could mark the tributary as unused, thereby permitting node 2.3 to send FSR data to node 2.16.

Another advantage of FSR arises because when network capacity is provisioned, the provisioned capacity often exceeds the immediate requirements for a particular channel between a particular pair of nodes. When the capacity is not fully utilized, the nodes insert data patterns representing silence or idle frames into the provisioned tributary. In synchronous networks, silence frames or idle frames are known bit patterns which are necessary for maintaining synchronization. Any other predetermined tributary data content can be similarly classified as a type of silent data. Additionally, in networks that carry digital signals representing continuous-time signals (such as voice) in addition to other data, a tributary representing negligible signal power could also be classified as a type of silent tributary.

An FSR-capable node can identify silent tributaries and replace these tributaries with FSR data for transport to another node. For example, consider FIG. 2 with nodes 2.15 and 2.16 having FSR capabilities. The relevant existing provisioned traffic includes node 2.2 using a specified tributary to send non-FSR data to node 2.4 along the working ring 2.5. Whenever node 2.15 identifies silence in this tributary, it can replace the silence frames with data for transport to node 2.16. However, FSR data can only be inserted into the tributary between the originating node 2.2 of the non-FSR data and the destination node 2.4 of the non-FSR data. This restriction can be overcome if an intermediate node switches the FSR data from one tributary to another tributary. If nodes along the path are appropriately implemented, they will permit switching the FSR data from one tributary to another. substantially transparently around the working ring 2.5. Additionally, the destination for the FSR data 2.16 must be able to regenerate the silent tributary necessary for the proper operation of the original destination node 2.4. If there is only one type of silent tributary used in a working ring 2.5, then node 2.16 can readily generate the required silent tributary. However, if a ring embodies a plurality of types of silent tributaries, then node 2.15 must be able to send information to node 2.16 so that node 2.16 can generate the particular type of silent tributary for transport to 2.4. Such information can readily be sent as FSR header information in the SPE for the tributary.

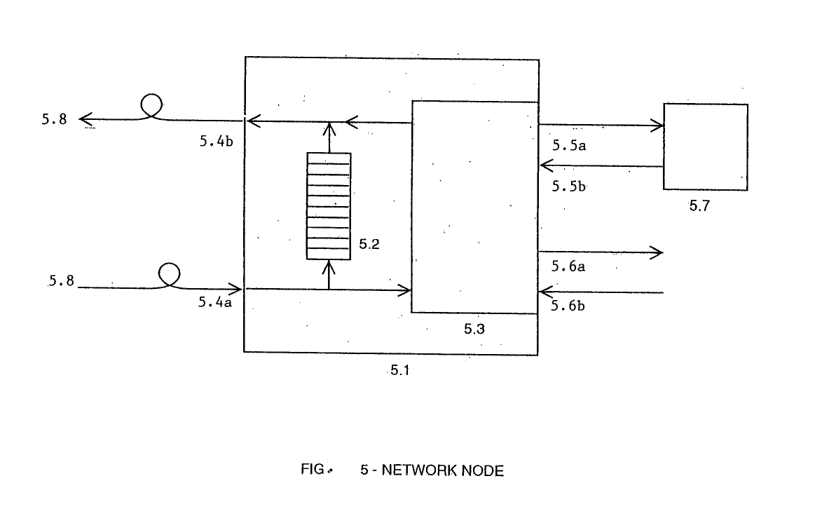

Additionally, FSR increases capacity utilization in data networks. As illustrated in FIG. 5, a switching or routing node 5.1 within a data network can become congested. For example, congestion can occur if the node 5.1 lacks the processing power or data buffering capability to handle line-rate inputs on any of its network interfaces 5.4-5.6. Congestion can also occur if the egress data rate on any interface 5.5 is less than the aggregate ingress rate for data that is destined for interface 5.5 from other interfaces 5.4 or 5.6. The egress data rate can be limited by the line rate of interface 5.5 or by some other network equipment 5.7 blocking traffic from interface 5.5.

If the ingress port 5.4a on an interface 5.4 on a SONET ring 5.8 becomes congested, the node 5.1 enters a blocking state on this interface 5.4. In this blocking state, ingress traffic from the SONET ring 5.8 into the interface 5.4 cannot be handled by node 5.1's processing system 5.3. Node 5.1 temporarily stores the traffic in a transit buffer 5.2 and then forwards the traffic back out around the ring 5.8 over egress port 5.4b. This traffic taxis around the ring 5.8 and will be processed by the node 5.1 during its next receipt by node 5.1 only if node 5.1 has unblocked the interface 5.4 by the time that the traffic has taxied around the ring 5.8. Otherwise, the traffic will continue to taxi around the ring 5.8 until the interface 5.4 becomes unblocked. Traffic that taxis around the ring 5.8 consumes network capacity that could otherwise be used. to transport other data traffic.

The additional network capacity provided by FSR can help reduce taxiing of blocked traffic. Consider FIG. 4 which illustrates a SONET system used to transport IP packets (or ATM cells). The capacity of the SONET ring is provisioned to provide the required optical transport capacity between SONET-connected equipment 4.1-4.4. Since IP and ATM traffic can be bursty, the available provisioned capacity typically is in excess of the mean traffic rate. Thus, SONET frames that are transported between any two nodes 4.2 and 4.4 typically have unused capacity within the SPE. For any tributary within an SPE, this unused capacity can constitute greater than half of the allocated capacity.

According to an aspect of the invention, an intermediate node, for example, node 4.3, inspects tributaries destined for node 4.4. If a tributary is not filled to capacity, its contents are stored within node 4.3, permitting an empty tributary to be sent to node 4.4. Therefore, at node 4.4, bandwidth is not wasted taxiing a partially-filled tributary around the ring back to node 4.4.

At node 4.4, the empty tributary is forwarded around the ring. Since this tributary is now empty, node 4.2 is free to reuse its capacity. Alternatively, the empty tributary sent by node 4.3 could be identified as a silence frame for use as noted above in the discussion of use of silence frames.

Once node 4.3 has aggregated a sufficient amount of data from partially-filled tributaries, node 4.3 then transmits the aggregated data to node 4.4 where it is switched or routed to its final destination. Node 4.3 requires a tributary for this purpose. The simplest way to obtain a tributary is to replace the most recent partially-filled tributary with the tributary that was aggregated by node 4.3. Of course, if the data in a partially-filled tributary is required to have low latency, it may not be practical to store it within node 4.3. To meet the required latency, node 4.3 may have to forward partially-filled low-latency tributaries rather than storing and aggregating them.

The identification of a partially-filled tributary can be exploited in another way. Node 4.3 can use the remaining capacity in the tributary to send data to node 4.4. For example, if a tributary that is provisioned for transporting traffic from node 4.2 to node 4.4 is 20% full, node 4.3 can fill the remaining 80% of the tributary and then transport the data to node 4.4. In this way, node 4.3 can transport data to node 4.4 using network capacity that was not provisioned for this purpose. In this discussion, node 4.3 was illustrated as between nodes 4.2 and 4.4. This orientation was for illustration purposes only, and is not required.

An alternative method for exploiting the capacity within partially-filled frames is to permit the frame to circulate, as in the prior art. However, as the frame passes through each FSR-capable node, the node can add data to the partially-filled frame, thereby improving capacity utilization.

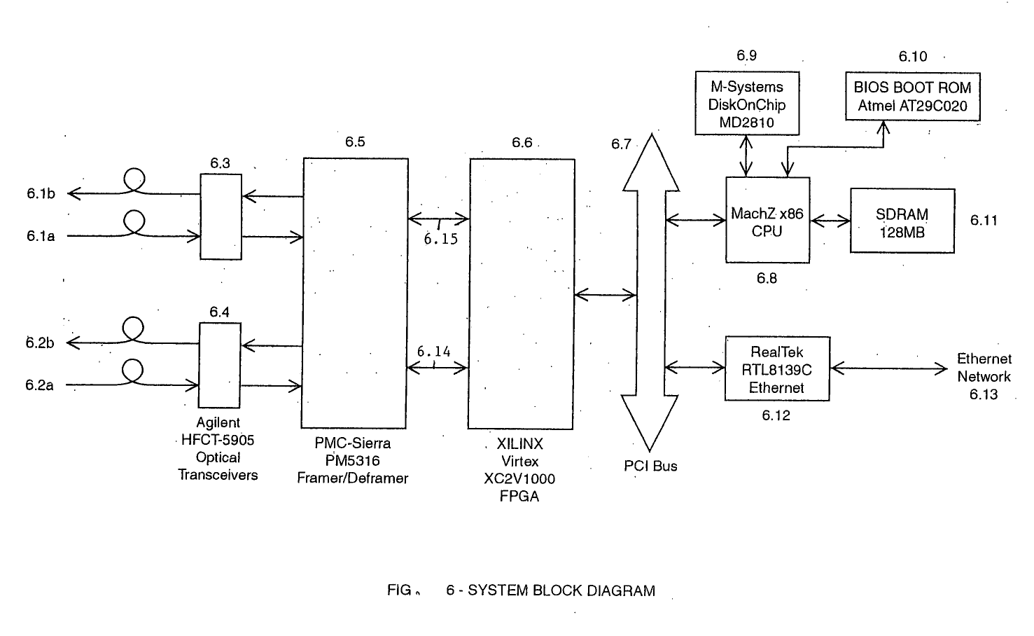

FIG. 6 illustrates a block diagram of an embodiment of the present invention. This embodiment is intended for use in a SONET OC-3 UPSR so there are two bidirectional connections 6.1-6.2 to the SONET ring. One connection 6.1 is to the working ring and the other connection 6.2 is to the protection ring. Two optical transceivers 6.3 and 6.4, such as, for example, Agilent HFCT-5905 optical transceivers, convert incoming photonic signals from the SONET ring 6.1, 6.2 at 6.1a, 6.2a into electrical signals which serve as inputs to a framer/deframer 6.5, such as, for example, a PMC-Sierra PM5316 SONET framer/deframer. The transceivers 6.3-6.4 also convert outgoing electrical signals from the framer/deframer 6.5 into photonic signals at 6.1b, 6.2b.

Although the embodiment illustrated in FIG. 6 is intended for use in a UPSR, only the operation of the working ring will be described in detail. The operation of the protection ring will be generally the same.

When a SONET frame is received, the framer/deframer 6.5 aligns the data stream to the SONET frame boundaries. The framer/deframer extracts the section, line, and path overhead bytes which are coupled via conductors 6.14 to a utilization device 6.6, such as, for example, a Xilinx XC2V1000 Field Programmable Gate Array (FPGA). The SPE is also extracted from the SONET frame and is coupled via a bus 6.15 to the FPGA 6.6. The FPGA contains an interface to a 32-bit Peripheral Component Interconnect (PCI) bus 6.7 which serves as the system bus. A system controller 6.8, such as, for example, a ZF Linux MachZ x86 system-on-a-chip, is also coupled to the PCI bus 6.7. The ZF Linux MachZ x86 system incorporates much of the functionality found on a conventional PC motherboard. One or more Ethernet devices 6.12, such as, for example, Realtek RTL8139C ICs are also coupled to the PCI bus 6.7. Each Ethernet device 6.12 provides an interface. to an external network 6.13. The external network can serve as the source or destination for FSR data.

The system controller 6.8 requires only a few external components including a non-volatile program and data store 6.9, illustratively, an M-Systems MD2810 DiskOnChip, a boot ROM 6.10, which illustratively is an Atmel AT 29C020 ROM, and a RAM 6.11, illustratively, 128 megabytes of SDRAM.

One or more of the tributaries need not be FSR-capable. Such tributaries undergo optical-to-electrical conversion by the optical receiver 6.1a and are then forwarded by the FPGA 6.6 through the framer/deframer 6.5 to the transmitter 6.1b.

Referring back to FIG. 2, at one FSR-capable node 2.15, the ingress traffic from one or more tributaries is replaced and subsequently, at a downstream FSR-capable node 2.16, the replacement traffic is received. The data in the replaced tributaries is discarded at node 2.15. Replacement tributaries are constructed using data that has been previously received from the external network 6.13 or data that has otherwise been generated by the system illustrated in FIG. 6. Since FSR can employ known network topology and the source-dropped tributaries typically found in legacy equipment, this tributary replacement is implemented in this mode of operation.

Continuing to refer to FIG. 2, the originating node for certain non-FSR traffic is node 2.4, and the destination for this non-FSR traffic is node 2.2. Without FSR, data in the tributary originating at node 2.4 would continue around the ring after reaching node 2.2 until it returns to node 2.4. However, the only byte of the tributary that needs to be transported from node 2.2 back to node 2.4 is the path overhead byte G1 illustrated in FIG. 3. The G1 byte is used by the receiving node 2.2 to inform the originating node 2.4 of the number of errors it received and for Remote Defect Indication. When FSR-capable node 2.15 removes a tributary, it saves this byte and makes it the first payload byte in the tributary that it creates. Upon receiving the FSR data, node 2.16 reads the saved G1 value from the input payload and puts it into the G1 byte of the path overhead for transport to node 2.4.

To implement a second aspect of the invention, it is necessary to detect silent or idle tributaries. The detection of such tributaries depends on the data representation for a particular silent/idle condition. However, once the data representation has been identified, each silent/idle condition can be treated in a similar manner.

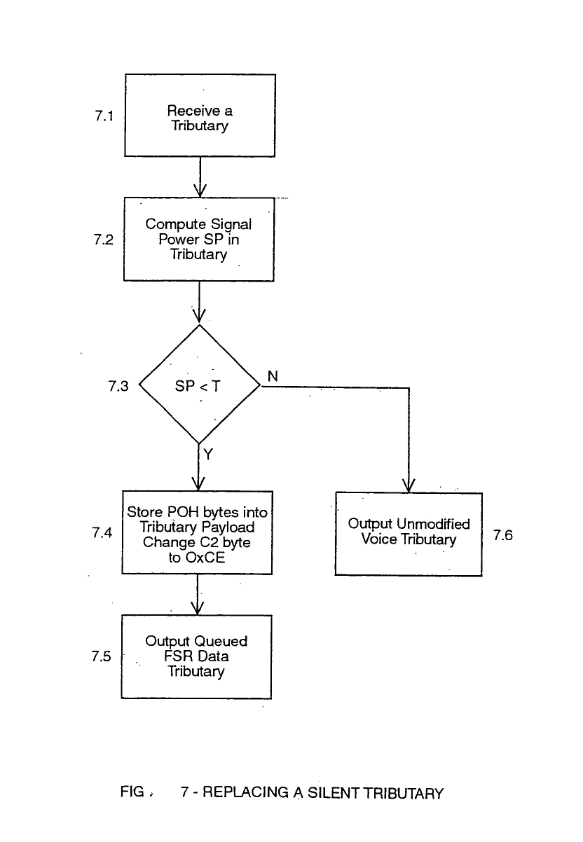

When the invention is used on a legacy SONET ring that primarily transports voice signals which have been digitized using Pulse Code Modulation (PCM), silent frames can be identified and temporarily replaced according to the flow diagram illustrated in FIG. 7. A tributary is received at 7.1. The signal power (SP) in the received tributary is computed at 7.2. The power can be computed, for example, by computing the root-mean-squared value of the sample values. SP can also be estimated by summing the absolute values of the signal sample values. This method simplifies the computation and reduces the dynamic range required by fixed-point hardware in the FPGA 6.6. SP is compared to a threshold value (T) at 7.3. T is a software-configurable threshold parameter. If SP is less than T. then the voice signal in the tributary has insignificant power. It is therefore classified as being silent and is replaced by FSR data. For transparency of operation between the source node for the voice data and the destination node for the voice data, it is necessary to save and forward some of the Path OverHead (POH) bytes illustrated in FIG. 3. These required POH bytes for the voice tributary are written into the start of the payload area for the FSR data at 7.4. In the illustrated embodiment, the POH bytes that are required to be forwarded are J1, B3, C2, F2, and H4. The rest of the payload is filled with FSR data. The value of the POH byte C2 is changed to CE (hexadecimal), to indicate to the receiving FSR node that the voice payload has been replaced by FSR data. The new tributary containing the FSR data is then queued for transport at 7.5.

If the voice signal power is not insignificant, then the voice tributary is forwarded unmodified, as illustrated at 7.6.

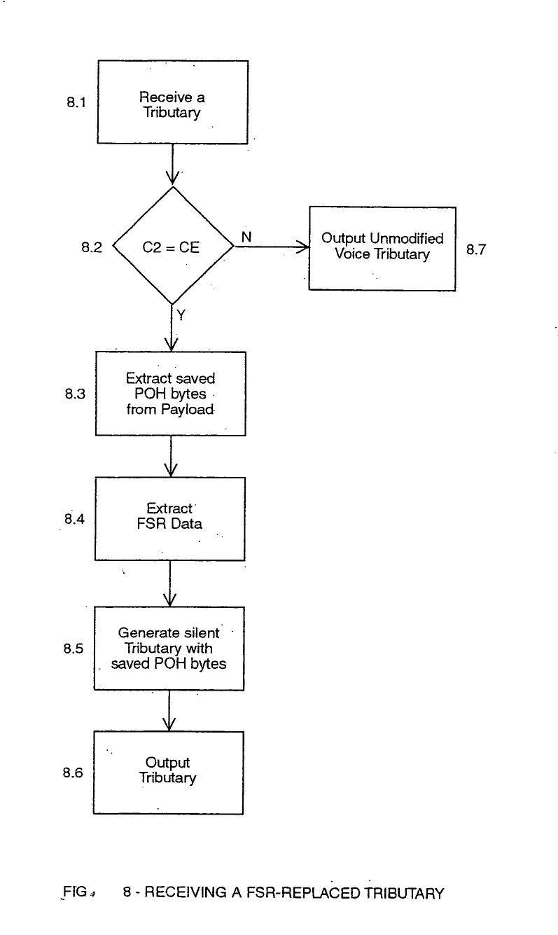

Referring now particularly to FIG. 8, an FSR-capable node receiving the tributary inspects the C2 byte of the POH at 8.2. If this byte does not equal CE (hexadecimal), then the input tributary does not contain FSR data. At 8.7, the input tributary is forwarded to the next node. If C2 equals CE (hexadecimal), then at 8.3 the POH bytes that were sent as part of the payload are extracted for use in constructing a replacement silent payload for the tributary. Then, at 8.4, the FSR data is extracted for further processing by this node. A tributary containing silent voice data is then constructed using the POH bytes that were extracted at 8.3 and this silent tributary is sent at 8.6 to the next node in the ring.

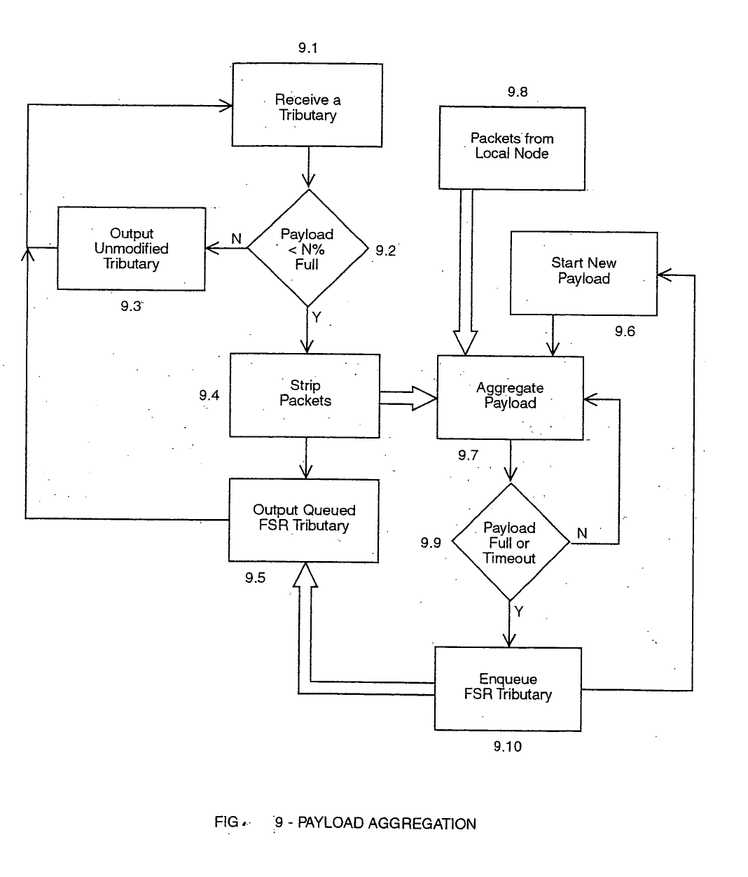

Referring now to FIG. 9, another aspect of FSR will be described in the context of transporting IP traffic over SONET using POS. However, FSR can be used for other transport applications including ATM over SONET. To implement this aspect of FSR, an FSR-capable node inspects the payload of the incoming tributary to determine if the payload is only partially full. In FIG. 9, the narrower arrows indicate control flow and the broader arrows indicate data flow. At 9.1, the tributary is received. At 9.2, the payload inside the tributary is parsed to determine if the payload is less than N percent full, where N is a software-configurable parameter that is typically between 10 and 90. At 9.3, if the payload is more than N percent full, the unmodified received tributary is sent to the next node. At 9.4, if the payload is less than N percent full, the packets from this payload are stripped and sent to a payload aggregator. Since the ingress tributary has been removed, at 9.5 an egress tributary is output from a queue of FSR tributaries.

The right side of FIG. 9 illustrates how new tributaries are constructed by the node. The process begins at 9.6 with an empty buffer for storing the tributary. At 9.7, this buffer gets filled with packets that were stripped at 9.4, plus packets from the local node 9.8. At 9.9, the buffer is tested to determine if it is sufficiently full to be queued for transmission. The buffer is tested to determine if its age (in milliseconds) exceeds a software-configured limit. This time limit is set to ensure that QoS is not degraded by excessive latency while packets are being aggregated into the tributary. If the tributary is ready to be sent, it is queued at 9.10 for transmission. If it is not yet ready, at 9.7 more data can be aggregated.

There are one or more aggregation buffers at 9.7, corresponding to priority queues and multiple destination modes. Priority queuing is also supported at 9.10 by having standard priority queuing.

Those skilled in the art will realize that the invention can be used in conjunction with network provisioning methods from the prior art. For example, node 2.2 could have specific tributaries that are provisioned for. data transport to node 2.3. It could gain additional capacity by using FSR on other tributaries.

Although the invention is described in the context of a SONET UPSR, those skilled in the art will realize that it is applicable to any network having a physical or virtual ring topology where the network capacity is allocated or channelized using any of (or any combination of) time-division multiplexing, frequency-division multiplexing, wavelength-division multiplexing, code-division multiplexing, or space-division multiplexing. This includes SONET and SDH bidirectional line-switched rings and virtual path-switched rings. Those skilled in the art will also realize that the invention is independent of the network protocol, and of the technology used for the physical layer of the network.

1. A method for transmitting data in a direction along a circuit coupling a first node from which first data is to be transmitted and a second node at which the first data is to be received and from which second data is to be transmitted, the method including assembling the first data into a frame at the first node for transmission to the second node, transmitting the frame including the first data from the first node, receiving the frame including the first data at the second node, removing at least a portion of the transmitted first data from the frame and replacing the removed first data with second data, and transmitting the frame containing the second data from the second node.

2. A method for transmitting data in a direction along a circuit coupling a first node from which first data is to be transmitted, a second node at which the first data is to be received and second data is to be transmitted, and a third node at which the second data is to be received and other data is to be transmitted, the method including assembling the first data into a frame for transmission to the second node, transmitting the frame including the first data in the direction from the first node, receiving the frame including the first data at the second node, removing at least a portion of the transmitted first data from the frame and replacing at least a portion of the removed first data with the second data, transmitting the frame in the direction from the second node, receiving the frame at the third node, removing from the frame at least a portion of the second data, replacing at least a portion of the removed second data with other data, and transmitting the frame in the direction from the third node.

3. The method of claim 2 wherein providing a third node includes providing a third node between the second node and the first node in the direction.

4. The method of claim 3 wherein replacing at least a portion of the removed second data with other data includes replacing at least a portion of the removed second data with removed first data.

5. The method of claim 2 wherein providing a third node includes providing a third node between the first node and the second node in the direction.

6. The method of claim 2 wherein providing a circuit includes providing a circuit supporting at least a first channel and a second channel and transmitting the frame including the first data in the direction from the first node, receiving the frame including the first data at the second node, removing at least a portion of the transmitted first data from the frame and replacing at least a portion of the removed first data with second data, transmitting the frame in the direction from the second node, receiving the frame at the third node, removing from the frame at least a portion of the second data, and transmitting the frame in the direction from the third node includes transmitting the frame including the first data in the direction from the first node on the first channel, receiving the frame including the first data at the second node on the first channel, removing at least a portion of the transmitted first data from the frame and replacing at least a portion of the removed first data with second data, transmitting the frame in the direction from the second node on the second channel, receiving the frame at the third node on the second channel, removing from the frame at least a portion of the second data, and transmitting the frame in the direction from the third node.

7. The method of claim 6 further including replacing at the third node at least a portion of the removed first data before transmitting the frame without the removed portion of the transmitted second-data from the third node.

8. A method for transmitting data along a circuit coupling a first node from which first data is to be transmitted, a second node from which second data is to be transmitted, and a third node at which the first data is to be received, the method including assembling the first data into a first frame for transmission, transmitting the first frame from the first node, receiving the first frame including the first data at the second node, removing at least a portion of the transmitted first data from the first frame and replacing at least a portion of the removed first data with the second data, transmitting the first frame from the second node, assembling at least a portion of the removed first data into a second frame, transmitting the second frame from the second node, receiving the second frame at the third node, and removing from the second frame at least a portion of the first data removed from the first frame and assembled into the second frame.

9. The method of claim 8 further including transmitting from the first node a third frame containing third data to be received at the third node, receiving the third frame including the third data at the second node, removing at least a portion of the third data from the third frame, and assembling at least a portion of the removed third data into the second frame along with the first data removed from the first frame and assembled into the second frame at the second node before transmitting the second frame from the second node and receiving the second frame at the third node, removing from the second frame at least a portion of the first data removed from the first frame and assembled into the second frame including removing from the second frame at least a portion of the third data removed from the third frame and assembled into the second frame.

10. Apparatus for transmitting data in a direction along a circuit, the apparatus including a first node for assembling first data into a frame and transmitting the first data through the circuit in the direction, a second node for receiving the frame transmitted through the circuit in the direction, removing at least a portion of the transmitted first data from the frame, replacing the removed first data with second data and transmitting the frame containing the second data through the circuit in the direction.

11. Apparatus for transmitting data in a direction along a circuit, the apparatus including a first node for assembling first data into a frame and transmitting the frame through the circuit in the direction, a second node for receiving the frame transmitted through the circuit in the direction, removing at least a portion of the transmitted first data from the frame, replacing the removed first data with second data and transmitting the frame containing the second data through the circuit in the direction, a third node for receiving the frame transmitted through the circuit in the direction, removing from the frame at least a portion of the second data, replacing the removed second data with other data, and transmitting the frame in the direction from the third node.

12. The apparatus of claim 11 wherein the third node is oriented between the second node and the first node in the direction.

13. The apparatus of claim 12 wherein the third node for replacing the removed second data with data other than the removed second data includes a third node for replacing the removed second data with removed first data.

14. The apparatus of claim 11 wherein the third node is oriented between the first node and the second node in the direction.

15. The apparatus of claim 11 wherein the circuit includes at least a first channel and a second channel, the first node including a first node for transmitting the frame including the first data in the direction on the first channel, the second node including a second node for receiving the frame including the first data on the first channel and transmitting the frame with at least a portion of the first data removed and replaced by the second data on the second channel, and the third node including a third node for receiving the frame on the second channel and transmitting the frame.

16. The apparatus of claim 15 wherein the third node includes a third node for replacing at least a portion of the removed first data before transmitting the frame without the removed portion of the transmitted second data.

17. Apparatus for transmitting data along a circuit, the apparatus including a first node for assembling first data into a first frame and transmitting the first data, a second node for receiving the first frame including the first data, removing at least a portion of the transmitted first data from the first frame, replacing at least a portion of the removed first data with second data, transmitting the first frame, assembling at least a portion of the removed first data into a second frame, and transmitting the second frame, and a third node for receiving the second frame and removing from the second frame at least a portion of the first data removed from the first frame and assembled into the second frame.

18. The apparatus of claim 17 wherein the first node includes a first node for transmitting a third frame containing third data to be received at the third node, the second node includes a second node for receiving the third frame including the third data, removing at least a portion of the third data from the third frame, and assembling at least a portion of the removed third data into the second frame along with the first data removed from the first frame and assembled into the second frame, and then transmitting the second frame from the second node, the third node including a third node for removing from the second frame at least a portion of the first data removed from the first frame and assembled into the second frame and at least a portion of the third data removed from the third frame and assembled into the second frame.

19. A method for transmitting data in a direction along a circuit coupling a first node from which first data is to be transmitted, a second node at which the first data is to be received, and a third node from which the second data is to be transmitted, the method including assembling the first data into a frame at the first node for transmission, transmitting the frame including the first data from, the first node, receiving the frame including the first data at the second node, removing at least a portion of the transmitted first data from the frame and replacing the removed first data with an indication that the portion of the frame previously occupied by the removed portion of the first data is available for data transport, transmitting the frame containing the indication from the second node, receiving the frame containing the indication at the third node, removing from the frame at least a portion of the indication, replacing the removed portion of the indication with the second data, and transmitting the frame from the third node.

20. Apparatus for transmitting data in a direction along a circuit, the apparatus including a first node for assembling the first data into a frame for transmission and transmitting the frame including the first data, a second node for receiving the frame including the first data, removing at least a portion of the transmitted first data from the frame and replacing the removed first data with an indication that the portion of the frame previously occupied by the removed portion of the first data is available for data transport and transmitting the frame containing the indication from the second node, and a third node for receiving the frame containing the indication, removing from the frame at least a portion of the indication, replacing the removed portion of the indication with the second data and transmitting the frame from the third node.
